(19) United States
(12) Patent Application Publication
(10) Pub. No.: US 2012/0138329 A1
(43) Pub. Date: Jun. 7, 2012

(54) STRUCTURE OF PNEUMATIC IMPACT WRENCH

(75) Inventors: YUNG-YUNG SUN, TAICHUNG COUNTY (TW); CHUAN-CHING CHENG, TAICHUNG CITY (TW)

(73) Assignee: STORM PNEUMATIC TOOL CO., LTD., TAICHUNG COUNTY (TW)

(21) Appl. No.: 12/959,652

(22) Filed: Dec. 3, 2010

(51) Int. Cl. B25B 21/02; B25F 5/02

(52) U.S. Cl. 173/221; 173/169

(57) ABSTRACT

An improved structure of a pneumatic impact wrench includes a main body, a plastic casing provided for fixing a motor casing and a motor module, the motor module having a cylinder for installing a rotor, the rotor being extended from an axle and supported by a bearing, the motor casing having an external case with a hardness greater than that of the plastic casing, and the external case being hollow and penetrating both ends to form a chamber for accommodating and installing a cylinder, and the external case having a stop ring protruded from an internal wall of the chamber and provided for blocking the cylinder, and an external case cover installed at a rear end of the external case for coupling and covering the external case cover.

### BACKGROUND OF THE INVENTION

1. Field of the Invention

The present invention relates to a pneumatic tool, and more particularly to an improved structure of a pneumatic impact wrench.

2. Description of the Related Art

With reference to FIG. 5 for a perspective view of a main body of a conventional pneumatic impact wrench, the conventional pneumatic impact wrench comprises a main body 8, a containing space 80 formed in the main body 8 for installing and accommodating a rotor 81, and other components such as a driving module (not shown in the figure). The main body 8 of the conventional impact wrench is generally made of aluminum, so that the structure of the conventional pneumatic impact wrench has the strength of a metal material and maintains a high precision of components, but aluminum is a lightweight metal with an appropriate strength and cannot be substituted by other metals easily when its cost is taken into consideration. As a result, the total weight of the conventional impact wrench cannot be reduced easily, and a plastic main body is introduced to substitute the main body made of aluminum.

With reference to FIG. 5, the main body 8′ made of a plastic material can further reduce the total weight of the impact wrench, but the weak structure of the plastic main body 8′ may be deformed by external forces easily. For example, a change of weather may cause a thermal expansion or contraction of the plastic material or an impact may cause a formation of the plastic material, so that a rotor 81′ installed in a containing space 80′ may not be operated smoothly, and the performance of the impact wrench is affected adversely. Therefore, an improved structure is introduced to overcome the foregoing problem.

With reference to FIG. 6 for an improved structure of a pneumatic impact wrench 9, a main body 90 is made of a plastic material, and a casing 92 made of a metal material is installed in the main body 90 to reinforce the plastic main body 90 in order to solve the problem of the plastic material having a poor structural strength, and a rotor 91 is accommodated and installed in the casing 92. The casing 92 as shown in FIG. 7 includes a chamber 920 for accommodating and installing the rotor 91, and the casing 92 as shown in FIG. 8 includes a closed end of the chamber 920 and an axle hole 921, and another end of the chamber 920 of the casing 92 is an open end covered by a cover 93. The cover 93 also has an axle hole 930 coaxially aligned with the axle hole 921 for pivotally installing the rotor 91.

The aforementioned casing 92 has the following problems:
1. The axle center A of the chamber 920 is upwardly biased with respect to the casing 92, and the axle center B of the axle hole 921 is downwardly biased with the axle center A of the chamber 920, and the axle hole 930 of the cover 93 is coaxially aligned with the axle hole 921 after the casing 92 is covered. Therefore, a very high manufacturing precision of the casing 92 and the cover 93 is required, and both of the manufacturing cost and the defective rate of the casing 92 are increased significantly.
2. From the external look of the casing 92, we understand that the casing 92 is casted and formed before the manufacture takes place, and the overall profile of the casing 92 is complicated, so that the design of the casting die of the casing 92 incurs a high level of difficulty, and it is necessary to enhance the hardness of an internal wall of the chamber 920 of the casing 92 by a surface treatment. However, the related surface treatment generally causes a severe pollution to the environment. in addition to its drawback of high manufacturing cost.

A key point of the present invention is to find a way of overcoming the aforementioned shortcomings of the conventional pneumatic impact wrench.

### SUMMARY OF THE INVENTION

Therefore, it is a primary objective of the present invention to overcome the aforementioned shortcomings of the prior art by providing an improved structure of a pneumatic impact wrench featuring a light weight and a sufficient structural strength, such that the pneumatic impact wrench can be manufactured with a lower cost and a better environmental protection without considering the precision of components, and the motor module can be installed precisely into the impact wrench.

To achieve the foregoing objective, the present invention comprises a main body, including a motor module and a switch module for controlling an air intake driving motor module; a handle, formed at a top end of the main body and integrally coupled to a plastic casing, and having an air intake passage formed therein, and the switch module being installed at the middle of the air intake passage for controlling the ON/OFF of the pneumatic impact wrench; a cylinder, installed in the motor module and having an air chamber formed in the cylinder. for installing a rotor, and a front cover and a rear cover covered onto both front and rear ends of the cylinder respectively, and each of both front and rear ends of the rotor having an axle extended from the front cover and the rear cover, and each of the front and rear covers having a bearing installed on an external side of each of the front and rear covers for pivotally supporting the two axles, and the axle of the rotor extended out from the front cover being coupled to an impact module, characterized in that the motor module is fixed into a motor casing, and the motor casing is fixed into the plastic casing, and a plurality of air intake passages is formed between the motor module and the motor casing and interconnected to the air intake holes of the air chamber respectively, and also interconnected from the air chamber to the external air outlet holes respectively, and the motor casing includes an external case and an external case cover, and the external case has a hardness greater than that of the plastic casing, and the external case is hollow and penetrates through both ends to define a chamber for accommodating and installing the cylinder, and the cylinder is installed into the chamber from a rear side of the chamber and fixed to the motor casing, and an internal wall of the chamber of the external case proximate to an end of the impact module includes a stop ring for stopping the front cover of the cylinder, and the rear end of the front cover. and the external case is coupled and covered by the external case cover.

### BRIEF DESCRIPTION OF THE DRAWINGS

FIG. 1 is a perspective view of the present invention;

FIG. 2 is an exploded view of the present invention;

FIG. 3 is a cross-sectional view of the present invention:

FIG. 4 is another cross-sectional view of the present invention;

FIG. 5 is a perspective view of a main body of a conventional pneumatic impact wrench;

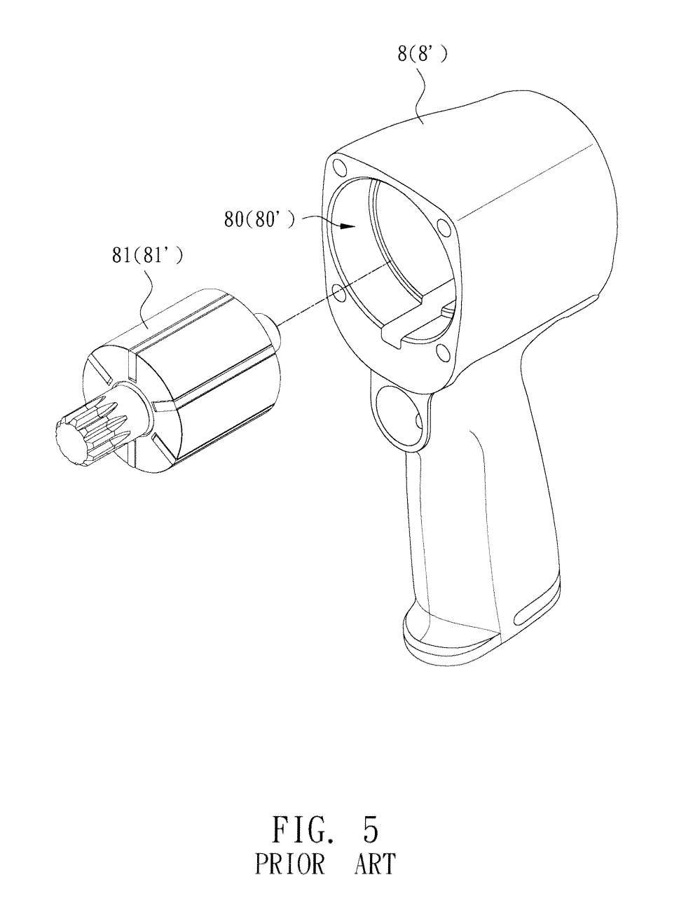

FIG. 6 is a cross-sectional view of another conventional pneumatic impact wrench;

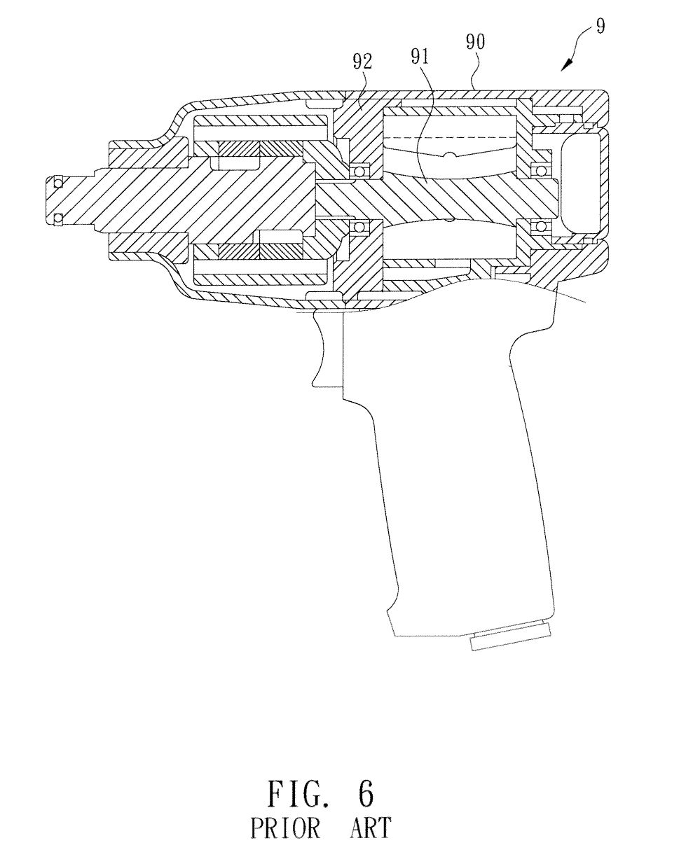

FIG. 7 is a perspective view of a casing of the conventional pneumatic impact wrench of FIG. 6: and

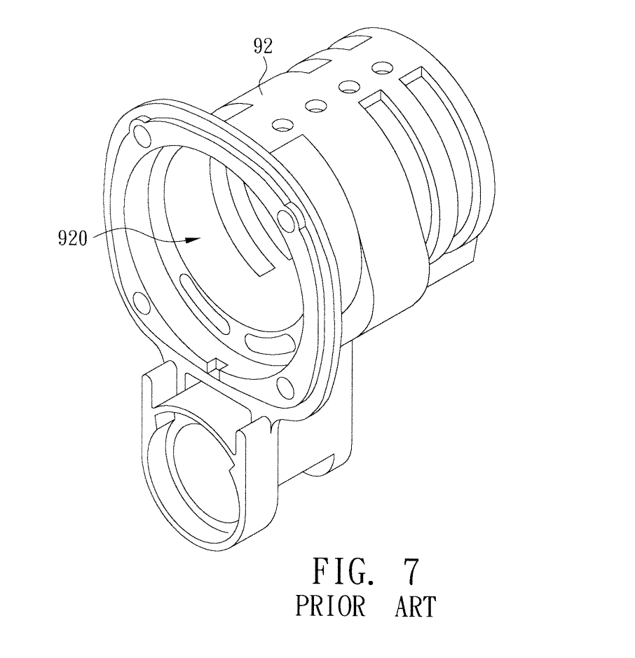

FIG. 8 is a cross-sectional view of a casing of the conventional pneumatic impact wrench of FIG. 6.

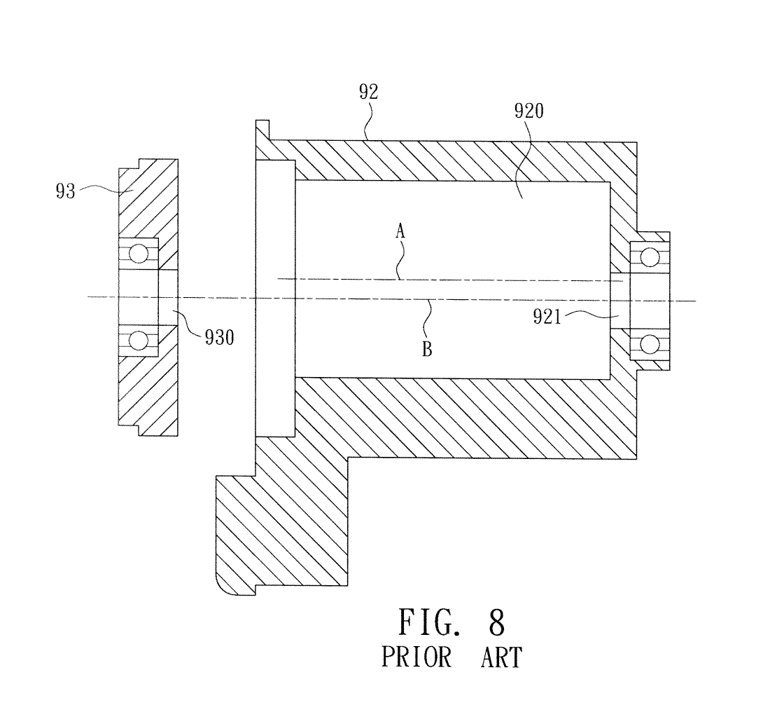

### DETAILED DESCRIPTION OF THE PREFERRED EMBODIMENTS

The foregoing and other objectives, characteristics and advantages of the present invention will become apparent by the detailed description of a preferred embodiment as follows. It is noteworthy to point out that each preferred embodiment is provided for the purpose of illustrating the present invention only. but not intended for limiting the scope of the patent claims.

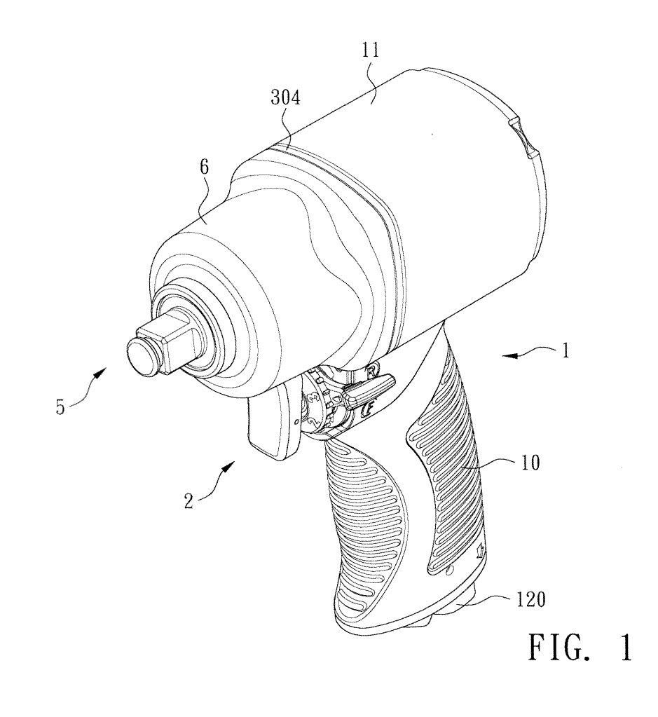

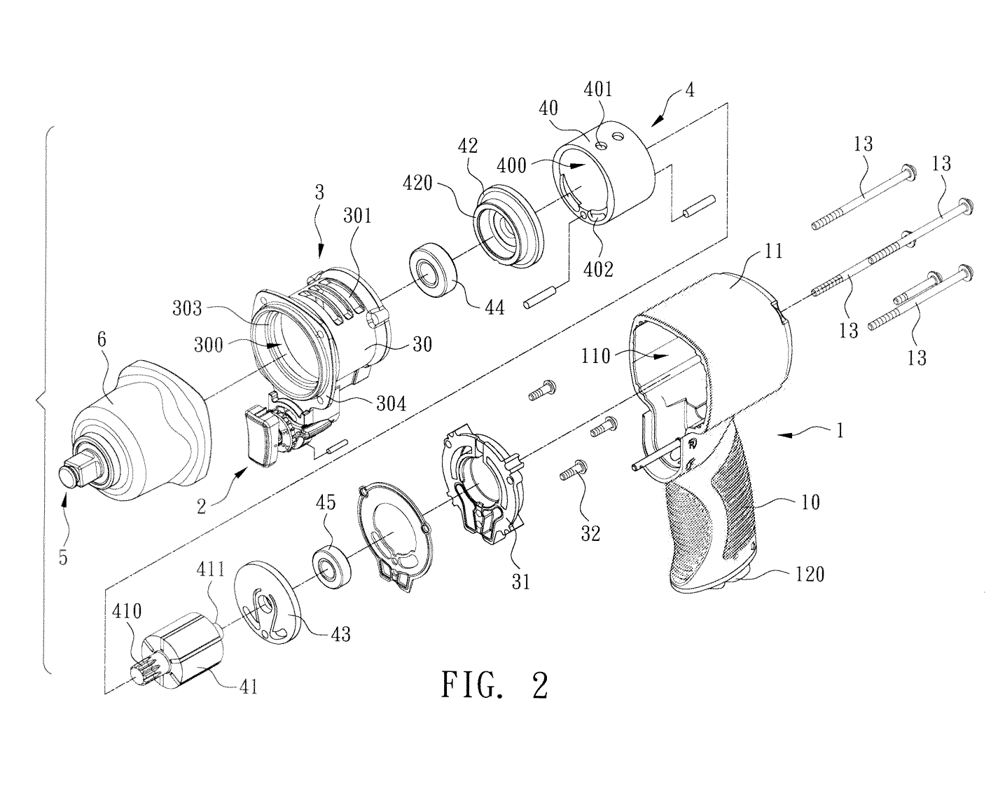

With reference to FIGS. 1 and 2 for an improved structure of a pneumatic impact wrench in accordance with a preferred embodiment of the present invention, the pneumatic impact wrench comprises a main body 1, a switch module 2, a motor casing 3, a motor module 4, and an impact module 5.

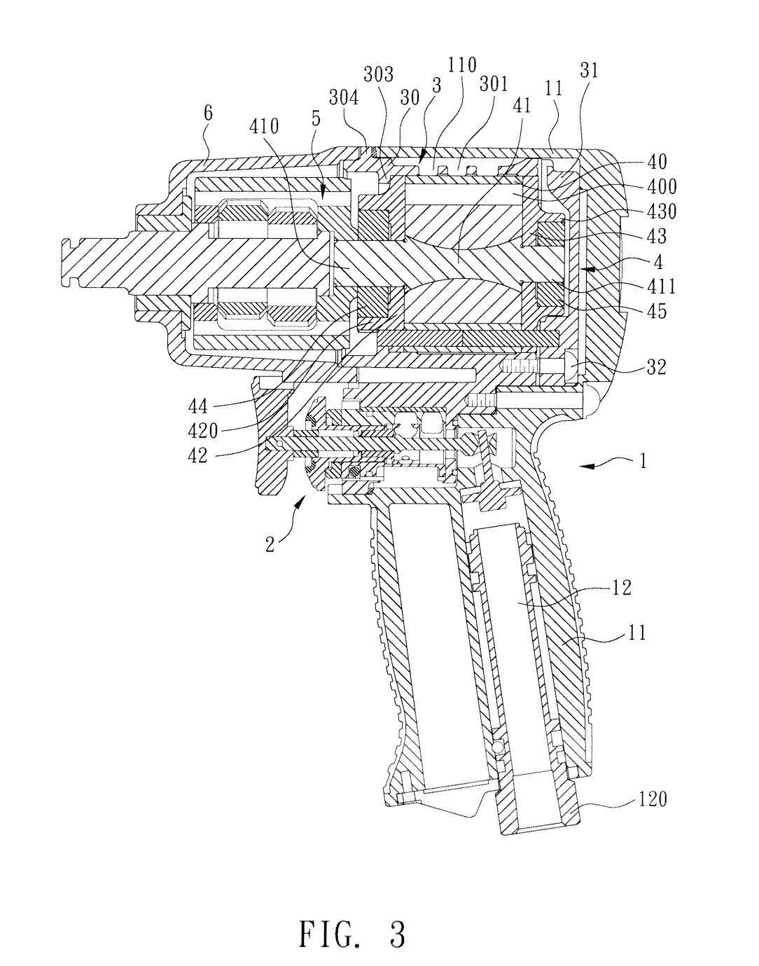

In FIGS. 2 and 3. the main body 1 includes a handle 10, and a plastic casing 11 coupled to a top end of the handle 10, and the handle 10 and the plastic casing 11 are integrally formed as a whole, and the handle 10 includes an air intake passage 12 formed therein and extended from the interior of the handle to the interior of the plastic casing 11. and the plastic casing 11 is a hollow casing having a containing space 110 therein, and the air intake passage 12 includes a connecting portion 120 exposed from the bottom of the handle 10 and connected to a high-pressure gas, and the switch module 2 is installed at the middle of the air intake passage 12 and provided for controlling a high-pressure gas in the air intake passage 12 to pass from the connecting portion 12 into the plastic casing 11.

In FIGS. 2 and 3, the motor casing 3 is installed in the containing space 110 of the plastic casing 11 and includes an external case 30 and an external case cover 31, and the external case 30 is made of a metal material in this preferred embodiment and has a hardness greater than the hardness of the plastic casing 11, and the external case 30 includes a hollow chamber 300 formed by penetrating through both ends. The external case 30 further includes a plurality of air outlet holes 301 formed at the top of the external case 30, and a plurality of air intake holes 302 formed at the bottom of the external case 30. Therefore, the structural shape of the motor casing 3 installed in the plastic casing 11 can be maintained and will not be deformed with the plastic casing 11, when the plastic casing 11 is affected by ambient conditions such as a thermal expansion/contraction or collision by other objects.

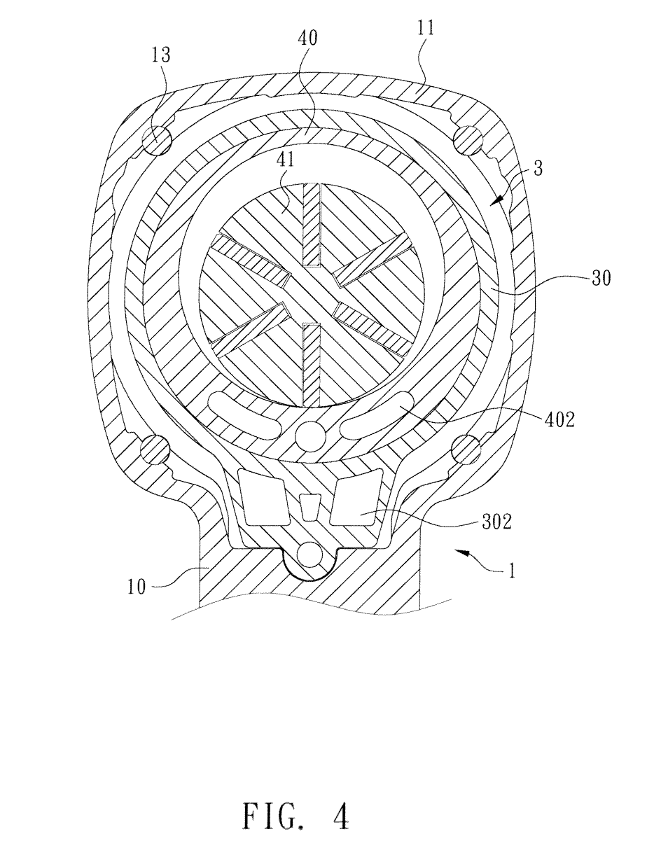

In FIGS. 2 to 4, the motor module 4 comprises a cylinder 40, a rotor 41, a front cover 42, a rear cover 43, and two bearings 44, 45. The motor module 4 installed from the rear side of the external case 30 into the chamber 300 by the cylinder 40, and the cylinder 40 includes an air chamber 400 provided for installing the rotor 41 therein. The front end of the cylinder 40 is coupled to the front cover 42. and the rear end of the cylinder 40 is coupled to the rear cover 43, for covering the air chamber 400 of the cylinder 40 and fixing the rotor 41 therein. The cylinder 40 includes a plurality of air outlet holes 401 formed at the top of the cylinder 40 and aligned with the air outlet holes 301 of the motor casing 3 respectively for discharging a waste gas from the air chamber 400, and the cylinder 40 further includes a plurality of air intake holes 402 formed at the bottom of the cylinder 40 and aligned with the air intake holes 302 of the motor casing 3 respectively for passing a high-pressure gas into the air chamber 400.

In FIGS. 2 and 3, the rotor 41 installed in the motor module 4 includes an axle 410 disposed at the front end of the rotor 41, extended from the front cover 42 and coupled to the impact module 5, and the rotor 41 further includes another axle 411 extended from the rear cover 43, and whose bearing 44 is fixed into a bearing housing 420 at an external side of the front cover 42 for pivotally supporting the axle 410, and another bearing 45 is fixed into a bearing housing 430 at an external side of the rear cover 43 for pivotally supporting the axle 411. A stop ring 303 is protruded inwardly towards an internal wall of the chamber 300 of the external case 30 proximate to an end of the impact module 5 for stopping the front cover 42 of the cylinder 40, and the external case cover 31 at a rear end of the plastic casing 11 is engaged to the chamber 300, wherein the external case cover 31 of this preferred embodiment is passed and secured to a rear end of the external case 30 by a plurality of screws 32 for fixing the cylinder 40 in the chamber 300.

In FIGS. 2 and 3, the motor casing 3 of this preferred embodiment includes a disc portion 304 extended axially towards a front end of the external case 30, such that after the motor casing 3 is fixed to the motor module 4, the external case 30 in the plastic casing 11 can be attached onto the plastic casing 11 by the internal side of the disc portion 304, and an external cover 6 disposed outside the impact module 5 can be attached onto an external side of the disc portion 304, and a plurality of screws 13 is passed from the exterior of the plastic casing 11 through the disc portion 304 and secured with the external cover 6. The external cover 6 presses the disc portion 304 to abut the motor casing 3 against the plastic casing 11.

From the description above, the plastic casing 11 of the main body 1 is made of a plastic material, such that the total weight of the impact wrench can be reduced, and the motor casing 3 made of a metal material and installed in the plastic casing 11 can reinforce the internal structure of the plastic casing 11 to prevent deformations. The motor module 4 is modulized and installed in the motor casing 3. and the axles 410, 411 disposed at both front end rear ends of the rotor 41 are pivotally installed to the bearings 44. 45 on external sides of the front cover 42 and rear cover 43 respectively, such that the rotor 41 can be driven and rotated in the air chamber 400 of the cylinder 40. The external case 30 and the external case cover 31 of the motor casing 3 are used for positioning the whole motor module. Unlike the conventional casing, the rotor 41 can be pivotally installed without requiring any axle hole formed on the external case cover 31 of the motor casing 3, so that the motor casing 3 does not require a high-precision manufacture, but the motor module 4 is just fixed into the impact wrench according to the correct position. The internal wall of the chamber 300 of the external case 30 no longer requires a surface treatment, so that the invention can lower the material and manufacturing costs without causing environmental pollutions during the manufacture of the components.

While the invention has been described by means of specific embodiments, numerous modifications and variations could be made thereto by those skilled in the art without departing from the scope and spirit of the invention set forth in the claims.

In summation of the description above, persons skilled in the art should know that the invention can achieve the aforementioned objectives. and the present invention complies with the patent application requirements, and thus is duly filed for patent application.

What is claimed is:

1. An improved structure of a pneumatic impact wrench, comprising: a main body, including a motor module and a switch module for controlling an air intake driving motor module; a handle, formed at a top end of the main body and integrally coupled to a plastic casing, and having an air intake passage formed therein, and the switch module being installed at the middle of the air intake passage for controlling the ON/OFF of the pneumatic impact wrench; a cylinder, installed in the motor module and having an air chamber formed in the cylinder for installing a rotor, and a front cover and a rear cover covered onto both front and rear ends of the cylinder respectively, and each of both front and rear ends of the rotor having an axle extended separately from the front cover and the rear cover, and each of the front and rear covers having a bearing installed on an external side of each of the front and rear covers for pivotally supporting the two axles, and the axle of the rotor extended out from the front cover being coupled to an impact module, characterized in that the motor module is fixed into a motor casing. and the motor casing is fixed into the plastic casing, and a plurality of air intake passages is formed between the motor module and the motor casing and interconnected to the air intake holes of the air chamber respectively, and interconnected from the air chamber to the external air outlet holes respectively, and the motor casing includes an external case and an external case cover, and the external case has s hardness greater than that of the plastic casing, and the external case is hollow and penetrates through both ends to define a chamber for accommodating and installing the cylinder, and the cylinder is installed into the chamber from a rear side of the chamber and fixed to the motor casing. and an internal wall of the chamber of the external case proximate to an end of the impact module includes a stop ring for stopping the front cover of the cylinder, and the rear end of the front cover, external case is coupled and covered by the external case cover.

2. The improved structure of a pneumatic impact wrench as recited in claim 1, wherein the motor casing at the front end of the external case is extended axially towards a disc portion, and the external case in the plastic casing is engaged with the plastic casing through an internal side of the disc portion, and an external cover is attached onto an external side of the disc portion for covering the impact module, and a plurality of screws is provided for passing from the exterior of the plastic casing through the disc portion to secure the external cover, and the external cover is provided for compressing the disc portion to tightly abut the motor casing against the plastic casing.

3. The improved structure of a pneumatic impact wrench as recited in claim 1, wherein the external case cover is secured at the rear end of the external case by a plurality of screws.

4. The improved structure of a pneumatic impact wrench as recited in claim 1, wherein the air outlet holes are formed on the external case and the cylinder respectively for interconnecting the air chamber to the outside, and the air intake holes are formed on the external case cover and the rear cover for interconnecting the air intake passage to the air chamber.

5. The improved structure of a pneumatic impact wrench as recited in claim 1, wherein the front cover and the rear cover include bearing housings disposed on external sides of the front and rear covers respectively, and each bearing is installed in the bearing house at a corresponding side.

6. The improved structure of a pneumatic impact wrench as recited in claim 1, wherein the stop ring is protruded inwardly from an internal wall of the chamber of the external case.
